(19) United States
(12) Patent Application Publication
(10) Pub. No.: US 2019/0372689 A1
(43) Pub. Date: Dec. 5, 2019

(54) SIGNAL TO NOISE DETERMINATION IN CELLPHONES

(71) Applicant: WIZR LLC, Santa Monica, CA (US)

(72) Inventors: David CARTER, Marina del Rey, CA (US); Genquan DUAN, Los Angeles, CA (US)

(73) Assignee: WIZR LLC, Santa Monica, CA (US)

(21) Appl. No.: 16/408,249

(22) Filed: May 9, 2019

Related U.S. Application Data
(60) Provisional application No. 62/668,930, filed on May 9, 2018.

(51) Int. Cl. H04B 17/336; H04W 24/10; G06N 20/00

(52) U.S. Cl. CPC H04B 17/336; H04W 88/02; G06N 20/00; H04W 24/10

(57) ABSTRACT

Signal-to-noise ratios are calculated for cellphones in a process that may be implemented in processing elements of the cellphones or in a SIM card. A signal for a cellular device is obtained, such as a voice stream, a message, or a data stream. The voice stream, for example, may be received as a part of a telephone call, as part of a voicemail message, as part of a VoIP call, or as part of a video messaging service, etc. The noise data is determined in the signal using a machine learning algorithm. The cellphone may include a model based on the identification of signals as desired signals or as noise. The model on the cellphone may be learned and updated incrementally, based on the identification of new signals as desired signals or as noise and based on the identification of signals by other systems.

### BRIEF DESCRIPTION OF THE FIGURES

These and other features, aspects, and advantages of the present disclosure are better understood when the following Detailed Description is read with reference to the accompanying drawings.

FIG. 1 illustrates a block diagram of a system 100 for signal to noise determination in cellphones.

FIG. 2 is a flowchart of an example process for signal to noise determination in cellphones according to some embodiments.

FIG. 3 shows an illustrative computational system for performing functionality to facilitate implementation of embodiments described herein.

### DETAILED DESCRIPTION

Systems and methods are disclosed for signal to noise determination in cellphones.

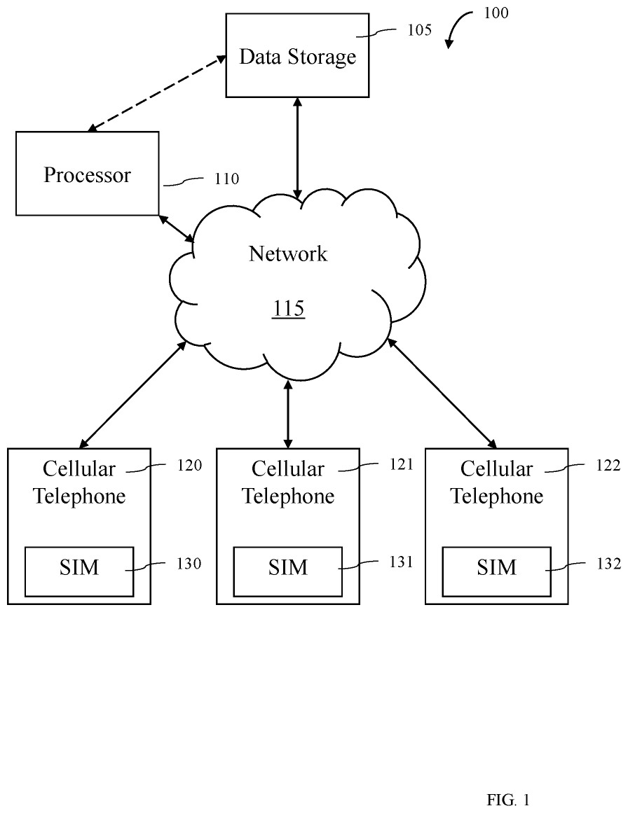

FIG. 1 illustrates a block diagram of a system 100 that may be used in various embodiments. The system 100 may include a plurality of cellular telephones: cellular telephone 120, cellular telephone 121, and cellular telephone 122. While three cellular telephones 120, 121, and 122 are shown, any number of cellular telephones may be included. The cellular telephones 120, 121, and 122 may be positioned anywhere such as, for example, within the same geographic location, in separate geographic locations, etc. In some embodiments, the cellular telephones 120, 121, and 122 may be owned and/or operated by different users, organizations, companies, entities, etc. In some embodiments, the cellular telephones 120, 121, and 122 may connect to cellular networks operated by different companies, a single cellular network operated by a single company, one or more wireless networks, and/or one or more other networks.

Each of the cellular telephones 120, 121, and 122 may have a unique subscriber identity module (SIM) card 130, 131, and 132 respectively. Although each cellular telephone 120, 121, and 122, is shown with one SIM card, in some embodiments some cellular telephones 120, 121, and 122 may include multiple SIM cards. For example, a cellular telephone 120, 121, and 122 may include two SIM cards. Each of the two SIM cards may be configured to interact with a cellular network in a different country. The SIM cards 130, 131, and 132 may include an international mobile subscriber identity (IMSI) number and the related key for the IMSI number. Each SIM card may include a processor, memory, storage, and other components.

The cellular telephones 120, 121, and 122 may be coupled with the network 115. The network 115 may, for example, include the Internet, a telephonic network, a wireless telephone network, a 3G network, etc. In some embodiments, the network may include multiple networks, connections, servers, switches, routers, etc. that may enable the transfer of data. In some embodiments, the network 115 may be or may include the Internet. In some embodiments, the network may include one or more LAN, WAN, WLAN, MAN, SAN, PAN, EPN, and/or VPN.

The system 100 may also include data storage 105 and/or a processor 110. In some embodiments, the data storage 105 and the processor 110 may be coupled together via a dedicated communication channel that is separate than or part of the network 115. In some embodiments, the data storage 105 and the processor 110 may share data via the network 115. In some embodiments, the data storage 105 and the processor 110 may be part of the same system or systems.

In some embodiments, the data storage 105 may include one or more remote or local data storage locations such as, for example, a cloud storage location, a remote storage location, etc.

In some embodiments, the data storage 105 may store data files related to the signal and noise experienced by the cellular telephones 120, 121, and 122 during data transfers and telecommunications sessions with other devices, including cellular telephones, traditional landline telephones, tablet computers, and other computing devices, via the network 115. For example, in some embodiments, during a telecommunications session between a cellular telephone 120, 121, and 122, and another device, the signal between the cellular telephone 120, 121, and 122, and the other device may become distorted or may include noise in addition to the desired signal.

Cellular devices may passively obtain signals from the environment in which they are located. Some of the signals obtained are desired signals such as, for example, messages or calls from friends, internet connectivity through a cellular network or wireless network, or positioning data from a positioning satellite system. However, cellular devices may also passively obtain undesired signals such as, for example, unauthorized or insecure connections to the cellphone, useless or harmful data sent to the cellphone, or other types of noise. Noise may include any unwanted modifications to the signal during the transmission of the signal from the cellular telephone 120, 121, and 122, to the other device and to the cellular telephone 120, 121, and 122, from the other device. Noise may include audio noise such as “hissing” or “humming” in an audio signal, video noise such as “snow,” radio noise such as “static,” and other varieties of noise experienced during the propagation of a signal from one device to another device. In some embodiments, the data files may be stored in any data format. In some embodiments, data files from the cellular telephones 120, 121, and 122 may be transferred to the data storage 105 using any data transfer protocol such as, for example, HTTP live streaming (HLS), real time streaming protocol (RTSP), Real Time Messaging Protocol (RTMP), HTTP Dynamic Streaming (HDS), Smooth Streaming, Dynamic Streaming over HTTP, HTML5, Shoutcast, etc.

In some embodiments, a data file may be recorded and stored in memory located at a user location prior to being transmitted to the data storage 105. In some embodiments, a data file may be created by a cellular telephone 120, 121, and 122 and/or by a SIM card 130, 131, and 132, and sent directly to the data storage 105. In some embodiments, a data file may be recorded and stored in memory located on a SIM card 130, 131, and 132. In these and other embodiments, a processor on the SIM card 130, 131, and 132 may process the data file.

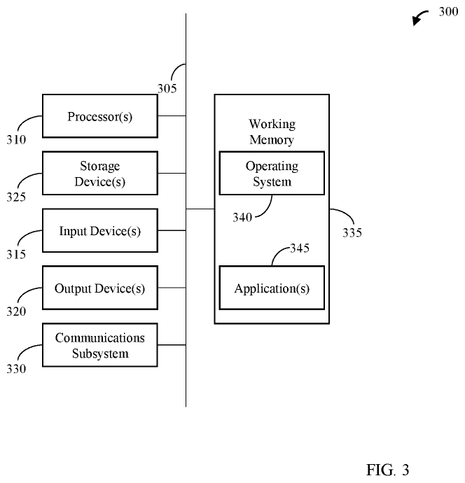

In some embodiments, the processor 110 may include one or more local and/or remote servers that may be used to perform data processing on data files stored in the data storage 105. In some embodiments, the processor 110 may execute one more algorithms on one or more data files stored with the storage location. In some embodiments, the processor 110 may execute a plurality of algorithms in parallel on a plurality of data files stored within the data storage 105. In some embodiments, the processor 110 may include a plurality of processors (or servers) that each execute one or more algorithms on one or more data files stored in data storage 105. In some embodiments, the processor 110 may include one or more of the components of computational system 300 shown in FIG. 3.

In some embodiments, a processor located on the SIM card 130, 131, and 132 may perform the processing of the data files generated by the cellular telephone 120, 121, and 122, and/or the SIM card 130, 131, and 132. In some embodiments, a processor on the SIM card 130, 131, and 132 may execute one more algorithms on one or more data files stored within the SIM card 130, 131, and 132. In some embodiments, the processor on the SIM card 130, 131, and 132 may execute a plurality of algorithms in parallel on a plurality of data files stored within the SIM card 130, 131, and 132. In some embodiments, the processor on the SIM card 130, 131, and 132 may include a plurality of processors that each execute one or more algorithms on one or more data files stored in the SIM card 130, 131, and 132. In some embodiments, the processor on the SIM card 130, 131, and 132 may include one or more of the components of computational system 300 shown in FIG. 3.

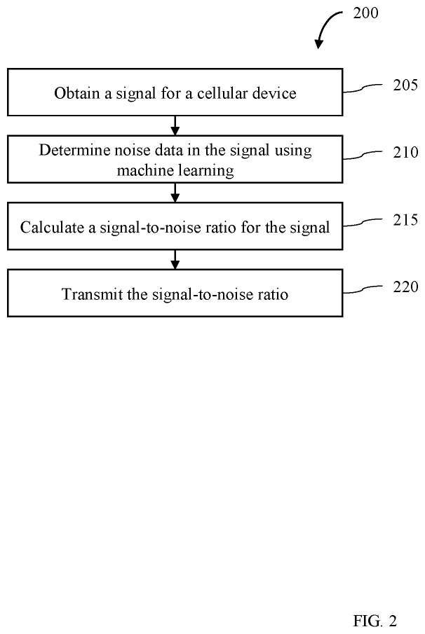

FIG. 2 is a flowchart of an example process 200 for calculating a signal-to-noise ratio in cellphones. One or more steps of the process 200 may be implemented, in some embodiments, by one or more components of system 100 of FIG. 1, such as the SIM cards 130, 131, and/or 132. Although illustrated as discrete blocks, various blocks may be divided into additional blocks, combined into fewer blocks, or eliminated, depending on the desired implementation.

Process 200 may begin at block 205. At block 205 the system 100 may obtain a signal for a cellular device 120, 121, and 122 such as, for example, a voice stream, a message, and/or a data stream. The voice stream, for example, may be received as a part of a telephone call, as part of a voicemail message, as part of a VoW call, or as part of a video messaging service, etc. Various other audio formats and/or protocols may be used. The message, for example, may be received as an SMS message, as an MMS message, etc. Various other messaging formats and/or protocols may be used. The data stream, for example, may be received as a part of a cellular data service plan, as part of a wireless network transmission, as part of message, etc. Various other data formats and/or protocols may be used. In some embodiments, the signals may contain identifying information such as a source of the signal and a purpose of the signal. For example, over a public wireless connection such as a public Wi-Fi connection, an individual may be able to send a signal to a cellphone connected to the wireless connection and may be able to retrieve private data from the cellphone. The connection to the cellphone may include information such as the connection source, which data will be transmitted to the cellphone, and which data will be obtained from the cellphone.

In some embodiments, at block 210 the system 100 may determine noise data in the signal using a machine learning algorithm on the signal received. In these and other embodiments, the system 100 may devise a mechanism to identify signals received, such as the signal obtained in block 205, as desired signals or as noise. In these and other embodiments, the system 100 may share the identification of signals as desired signals or as noise with other systems. For example, in some embodiments, multiple systems 100 may be performing the operations of identifying signals as desired signals or as noise. Each of the multiple systems 100 may share the identification of desired signals and noise along with attributes of the signals to each of the other systems 100.

In some embodiments, a cellphone may include a model based on the identification of signals as desired signals or as noise. The model on the cellphone may be learned and updated incrementally, based on the identification of new signals as desired signals or as noise and based on the identification of signals by other systems 100. The cellphone may learn a binary classification model.

The binary classification model may include extracting low level features for all signals. In some embodiments, the features may be considered as 1-D data. In these and other embodiments, the data may have a length n. In these and other embodiments, a 4 scale feature map with filters 1×1, 1×2, 1×4, and 1×8 may be built. The feature maps may be used with raw input and gradient input to generate a series of binaries as the extracted low level features. In some embodiments, the raw input may include the input as generated by a device, such as a cellular telephone. In some embodiments, the gradient input may include a difference between neighboring data points of the raw input. In some embodiments, the gradient input may represent a derivative of the raw input. In these and other embodiments, the gradient input may be generated from the raw input. For example, in some embodiments, the raw input may include an input in a spatial domain. The spatial domain may include an image space. In these and other embodiments, the raw input may include data about each pixel of the image. For example, the raw input may have one or more color values associated with each pixel. The gradient input for the image may include the difference between each pixel and neighboring pixels.

In some embodiments, such as, for example, a sound input, the raw input may be transformed to a time-frequency domain. In some embodiments, an input in the spatial domain may be transformed into an input in the time-frequency domain by using a transformation such as a Fast Fourier Transform. The feature maps may be applied to raw input and gradient input of spatial domains, time-frequency domains, and other domains. The learning algorithm may learn weak classifiers based on the low level features for each signal map. In some embodiments, the learning algorithm may learn strong classifiers. In these and other embodiments, the strong classifiers may be a concatenation of the weak classifiers. In some embodiments, the learning algorithm may be used to identify desired signals and noise in the signal obtained in block 205.

In some embodiments, at block 215 the system 100 may calculate a signal-to-noise ratio for the signal based on the signal obtained at block 205 and the noise data determined at block 210.

In some embodiments, at block 220 the system 100 may transmit the signal-to-noise ratio calculated at block 215.

The computational system 300 (or processing unit) illustrated in FIG. 3 can be used to perform and/or control operation of any of the embodiments described herein. For example, the computational system 300 can be used alone or in conjunction with other components. As another example, the computational system 300 can be used to perform any calculation, solve any equation, perform any identification, and/or make any determination described here.

The computational system 300 may include any or all of the hardware elements shown in the figure and described herein. The computational system 300 may include hardware elements that can be electrically coupled via a bus 305 (or may otherwise be in communication, as appropriate). The hardware elements can include one or more processors 310, including, without limitation, one or more general-purpose processors and/or one or more special-purpose processors (such as digital signal processing chips, graphics acceleration chips, and/or the like); one or more input devices 315, which can include, without limitation, a mouse, a keyboard, and/or the like; and one or more output devices 320, which can include, without limitation, a display device, a printer, and/or the like.

The computational system 300 may further include (and/or be in communication with) one or more storage devices 325, which can include, without limitation, local and/or network-accessible storage and/or can include, without limitation, a disk drive, a drive array, an optical storage device, a solid-state storage device, such as random access memory (“RAM”) and/or read-only memory (“ROM”), which can be programmable, flash-updateable, and/or the like. The computational system 300 might also include a communications subsystem 340, which can include, without limitation, a modem, a network card (wireless or wired), an infrared communication device, a wireless communication device, and/or chipset (such as a Bluetooth® device, a 802.6 device, a Wi-Fi device, a WiMAX device, cellular communication facilities, etc.), and/or the like. The communications subsystem 340 may permit data to be exchanged with a network (such as the network described below, to name one example) and/or any other devices described herein. In many embodiments, the computational system 300 will further include a working memory 335, which can include a RAM or ROM device, as described above.

The computational system 300 also can include software elements, shown as being currently located within the working memory 335, including an operating system 340 and/or other code, such as one or more application programs 345, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 325 described above.

In some cases, the storage medium might be incorporated within the computational system 300 or in communication with the computational system 300. In other embodiments, the storage medium might be separate from the computational system 300 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 300 and/or might take the form of source and/or installable code, which, upon compilation and/or installation on the computational system 300 (e.g., using any of a variety of generally available compilers, installation programs, compression/decompression utilities, etc.), then takes the form of executable code.

The term “substantially” means within 5% or 10% of the value referred to or within manufacturing tolerances.

Various embodiments are disclosed. The various embodiments may be partially or completely combined to produce other embodiments.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for-purposes of example rather than limitation, and does not preclude inclusion of such modifications, variations, and/or additions to the present subject matter as would be readily apparent to one of ordinary skill in the art.

1.-3. (canceled)

4. A method for calculating a signal-to-noise ratio, the method comprising:
obtaining a signal for a cellular device;
determining noise data in the signal using machine learning;
calculating a signal-to-noise ratio for the signal; and;
transmitting the signal-to-noise ratio.
